(19) United States
(12) Patent Application Publication
(10) Pub. No.: US 2026/0072378 A1
(43) Pub. Date: Mar. 12, 2026

(54) DEVELOPING DEVICE AND IMAGE FORMING SYSTEM

(71) Applicant: FUJIFILM Business Innovation Corp., Tokyo (JP)

(72) Inventor: Kento TERASHIMA, Kanagawa (JP)

(73) Assignee: FUJIFILM Business Innovation Corp., Tokyo (JP)

(21) Appl. No.: 19/062,922

(22) Filed: Feb. 25, 2025

(30) Foreign Application Priority Data
Sep. 9, 2024 (JP) 2024-155313

(51) Int. Cl. G03G 15/08

(52) U.S. Cl. CPC G03G 15/0881

(57) ABSTRACT

A developing device includes: a housing that accommodates a developer and that has an opening facing an image holding body capable of holding a latent image; a developing member that is rotatably provided in the housing, that is exposed from the opening, that is capable of holding the developer on an outer periphery of the developing member, and that develops the latent image with the held developer while rotating; and a covering member that covers a gap between the developing member and the housing downstream of a development position of the developing member in a rotation direction, that covers a first region in the gap corresponding to one end portion of the developing member in a rotation axis direction, and that does not cover at least a part of an intermediate region in the gap corresponding to a region between both end portions of the developing member in the rotation axis direction.

### CROSS-REFERENCE TO RELATED APPLICATIONS

This application is based on and claims priority under 35 USC 119 from Japanese Patent Application No. 2024-155313 filed September 9, 2024.

### BACKGROUND

### (i) Technical Field

The present disclosure relates to a developing device and an image forming system.

### (ii) Related Art

JP2023-013157A discloses a developing device. The developing device includes a developing container, a developer supporting body, a restricting portion, a facing portion, a sealing portion, and a sealing member. The developing container accommodates a developer containing a toner and a carrier. The developer supporting body is a rotatable developer supporting body that supports and transports the developer toward a development position where an electrostatic image formed on an image supporting body is developed. This developer supporting body has a supporting region and a non-supporting region. The supporting region is a region of the developer supporting body that has a developer transporting ability. The non-supporting region is a region of the developer supporting body that does not have the developer transporting ability. The restricting portion restricts the amount of the developer supported in the supporting region. The facing portion is disposed to face the developer supporting body in a position downstream of the restricting portion and upstream of the development position in a rotation direction of the developer supporting body. The sealing portion has flexibility and is provided to face the supporting region and the non-supporting region so as to come into contact with the developer supported in the supporting region. The sealing member is provided in the sealing portion so as to be sandwiched between the sealing portion and the non-supporting region.

JP2013-200379A discloses a developing device. The developing device includes a developer supporting body, a developer supply member, a casing, and an agitating member. The developer supporting body transports a developer to an image supporting body. The developer supply member supplies the developer to the developer supporting body. The casing accommodates the developer. The agitating member supplies the developer to the developer supply member while agitating the developer in the casing by a rotating operation. In addition, the developer supporting body includes a first electrode and a second electrode provided with respect to the first electrode through an insulator. In this developing device, the developer on the developer supporting body is clouded by applying a voltage at which a potential difference between the first electrode and the second electrode is temporally reversed. Then, a surface of the developer supporting body is moved to transport the developer to a development region such that an electrostatic latent image formed on the image supporting body is developed. The developer remaining on the developer supporting body after development is allowed to enter a device through an opening portion between the developer supporting body and an opening portion forming member that is provided to form a certain gap between the developer supporting body and the opening portion forming member, and then the developer is recovered by the developer supply member. In addition, the developing device is provided with an abutting member that is caused to abut the developer supply member to block a gap between the developer supply member and the casing such that leakage of the developer to the outside of the device due to the gap and the opening portion communicating with each other is inhibited.

JP2016-180829A discloses a developing device. The developing device includes a developing housing, a developer holding body, a layer thickness regulating member, and a sealing member. The developing housing accommodates a developer therein and has an opening facing an image holding body capable of holding an electrostatic latent image. The developer holding body is provided so as to face the opening of the developing housing. The developer holding body holds and transports the developer while rotating facing the image holding body. The layer thickness regulating member is provided in an upstream gap of a gap formed between the developer holding body and the developing housing, the upstream gap being located upstream of the opening in a rotation direction of the developer holding body. This layer thickness regulating member regulates a layer thickness of the developer on the developer holding body. The sealing member is provided in a downstream gap of the gap formed between the developer holding body and the developing housing, the downstream gap being located downstream of the opening in the rotation direction of the developer holder. The sealing member is formed of a flexible plate material that extends in a long shape along a rotation axis direction of the developer holding body. In addition, the sealing member seals the downstream gap by fixing an upstream side in a width direction along the rotation direction of the developer holding body to the developing housing and bringing a downstream side in the width direction into contact with the developer on the developer holding body. Furthermore, the sealing member has, with respect to the rotation axis direction of the developer holding body, a plurality of cut portions that occupy, in a dimension from a free end to a fixed end in the width direction, 60% or more from a free end side, and that have an angle of 30° or less with respect to a reference line along the rotation direction of the developer holding body.

### SUMMARY

Aspects of non-limiting embodiments of the present disclosure relate to a circuit board-equipped apparatus that suppress an increase in internal pressure of a housing, compared to a configuration in which the entire region of a gap formed between a developing member and a housing is covered with a covering member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a housing that accommodates a developer and that has an opening facing an image holding body capable of holding a latent image; a developing member that is rotatably provided in the housing, that is exposed from the opening, that is capable of holding the developer on an outer periphery of the developing member, and that develops the latent image with the held developer while rotating; and a covering member that covers a gap between the developing member and the housing downstream of a development position of the developing member in a rotation direction, that covers a first region in the gap corresponding to one end portion of the developing member in a rotation axis direction, and that does not cover at least a part of an intermediate region in the gap corresponding to a region between both end portions of the developing member in the rotation axis direction.

### BRIEF DESCRIPTION OF THE DRAWINGS

Exemplary embodiment(s) of the present invention will be described in detail based on the following figures, wherein:

FIG. 1 is a schematic view showing an image forming apparatus according to the present exemplary embodiment;

FIG. 2 is a side cross-sectional view of a developing device shown in FIG. 1;

FIG. 3 is a front view of the developing device shown in FIG. 2 as viewed from an opening portion side;

FIG. 4 is a cross-sectional view taken along line 4-4 of FIG. 3;

FIG. 5 is an enlarged view of a main part of the developing device according to the present exemplary embodiment (a partially enlarged view of FIG. 2);

FIG. 6 is an enlarged view of the main part of the developing device according to the present exemplary embodiment (a partially enlarged view of FIG. 4);

FIG. 7 is an enlarged view of the main part of the developing device according to the present exemplary embodiment (an enlarged view of an open region);

FIG. 8 is a front view of a developing device according to another exemplary embodiment as viewed from an opening portion side;

FIG. 9 is a front view of a developing device according to another exemplary embodiment as viewed from an opening portion side; and

FIG. 10 is a cross-sectional view taken along line 10-10 shown in FIG. 9.

### DETAILED DESCRIPTION

Hereinafter, an exemplary embodiment of the present disclosure will be described with reference to the drawings.

### Image Forming Apparatus 10

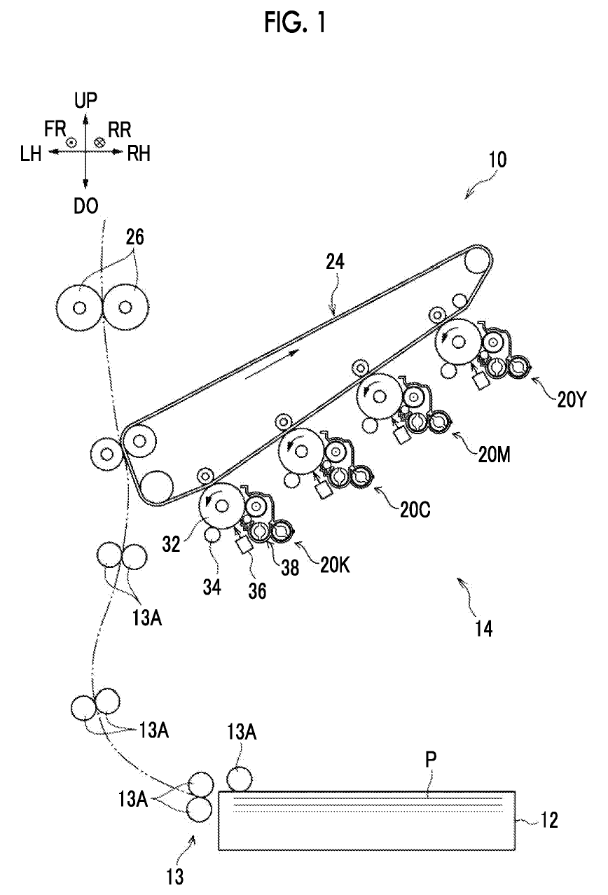

A configuration of an image forming apparatus 10 to which an image forming system according to the present exemplary embodiment is applied will be described. FIG. 1 is a schematic view showing the configuration of the image forming apparatus 10 according to the present exemplary embodiment.

Note that an arrow UP shown in the drawings represents an upper side (more specifically, an upper side in a vertical direction) of the apparatus, and an arrow DO represents a lower side of the apparatus (specifically, a lower side in the vertical direction). In addition, an arrow LH shown in the drawings represents a left side of the apparatus and an arrow RH represents a right side of the apparatus. Furthermore, an arrow FR shown in the drawings represents a front side of the apparatus and an arrow RR represents a rear side of the apparatus. Since these directions are directions defined for the convenience of description, the configuration of the apparatus is not limited to these directions. The term “apparatus” may be omitted in each direction of the apparatus. That is, for example, “the upper side of the apparatus” may simply be described as “the upper side”.

In addition, in the following description, the term “up-down direction” may be used to mean “both the upper side and the lower side” or “any one of the upper side or the lower side”. The term “right-left direction” may be used to mean “both the right side and the left side” or “any one of the right side or the left side “. The “right-left direction” may also be referred to as a lateral side, a transverse direction, and a horizontal direction. The term “front-rear direction” may be used to mean “both the front side and the rear side” or “any one of the front side or the rear side”. The “front-rear direction” may also be referred to as a lateral side, a transverse direction, and a horizontal direction. In addition, the up-down direction, the right-left direction, and the front-rear direction are directions that intersect each other (specifically, directions orthogonal to each other).

In addition, a symbol in which “×” is written in “○” in the drawings means an arrow pointing from the front to the back of the paper. Furthermore, a symbol in which “•” is written in “○” in the drawings means an arrow pointing from the back to the front of the paper.

The image forming apparatus 10 shown in FIG. 1 is an apparatus that forms an image. Specifically, as shown in FIG. 1, the image forming apparatus 10 includes a medium accommodation section 12, a transport section 13, and an image forming section 14. Hereinafter, each section of the image forming apparatus 10 will be described.

### Medium Accommodation Section 12

The medium accommodation section 12 is a section that accommodates a recording medium P in the image forming apparatus 10. The recording medium P accommodated in the medium accommodation section 12 is supplied to the image forming section 14. The recording medium P accommodated in the medium accommodation section 12 is an object on which an image is formed by the image forming section 14. Examples of the recording medium P include a paper sheet and a film. Examples of the film include a resin film and a metal film. Note that the recording medium P is not limited to the media described above, and various recording media can be used.

### Transport Section 13

The transport section 13 shown in FIG. 1 transports the recording medium P stored in the medium accommodation section 12 to a discharge section (not shown). Specifically, as shown in FIG. 1, the transport section 13 includes a plurality of transport members 13A such as transport rolls, and transports the recording medium P by the transport members 13A. Note that the transport member 13A may be, for example, a transport member such as a transport belt and a transport drum and various transport members may also be used.

### Image Forming Section 14

The image forming section 14 shown in FIG. 1 forms an image on the recording medium P transported by the transport section 13 (specifically, the transport member 13A). Specifically, the image forming section 14 forms a toner image (an example of an image) on the recording medium P by an electrophotographic method. More specifically, as shown in FIG. 1, the image forming section 14 includes toner image forming units 20Y, 20M, 20C, and 20K (hereinafter, referred to as 20Y to 20K), a transfer body 24, and a fixing unit 26.

Each of the toner image forming units 20Y to 20K includes a photoreceptor 32. Since the toner image forming units 20Y to 20K have the same configuration, reference numerals for the respective units of the toner image forming units 20Y, 20M, and 20C are omitted in FIG. 1.

The photoreceptor 32 is an example of an image holding body, and is a structure that holds a latent image. Specifically, the photoreceptor 32 rotates in one direction (for example, a counterclockwise direction in FIG. 1). In the vicinity of the photoreceptor 32, a charging device 34, an exposing device 36, and a developing device 38 are provided in this order from an upstream side in a rotation direction of the photoreceptor 32.

In each of the toner image forming units 20Y to 20K, the charging device 34 charges the photoreceptor 32 (a charging step). Furthermore, the exposing device 36 exposes the photoreceptor 32, which is charged by the charging device 34, to form a latent image (specifically, an electrostatic latent image) on the photoreceptor 32 (exposing step). The photoreceptor 32 holds the latent image formed by the exposing device 36.

Then, the developing device 38 develops the latent image held by the photoreceptor 32 (developing step). Accordingly, a toner image is formed on the photoreceptor 32. A specific configuration of the developing device 38 will be described later.

In the image forming section 14, the toner image forming units 20Y to 20K perform the charging step, the exposing step, and the developing step to form toner images of respective colors which are yellow (Y), magenta (M), cyan (C), and black (K) on the transfer body 24. Furthermore, in the image forming section 14, the toner images of the respective colors that are formed on the transfer body 24 are transferred to the recording medium P and the toner images are fixed onto the recording medium P by the fixing unit 26. As described above, the image forming section 14 uses an intermediate transfer method in which an image is transferred to the recording medium P via the transfer body 24.

The image forming section is not limited to the intermediate transfer method. For example, a direct transfer method in which an image is directly transferred to the recording medium P may be used, and various image forming sections can also be applied.

### Developing Device 38

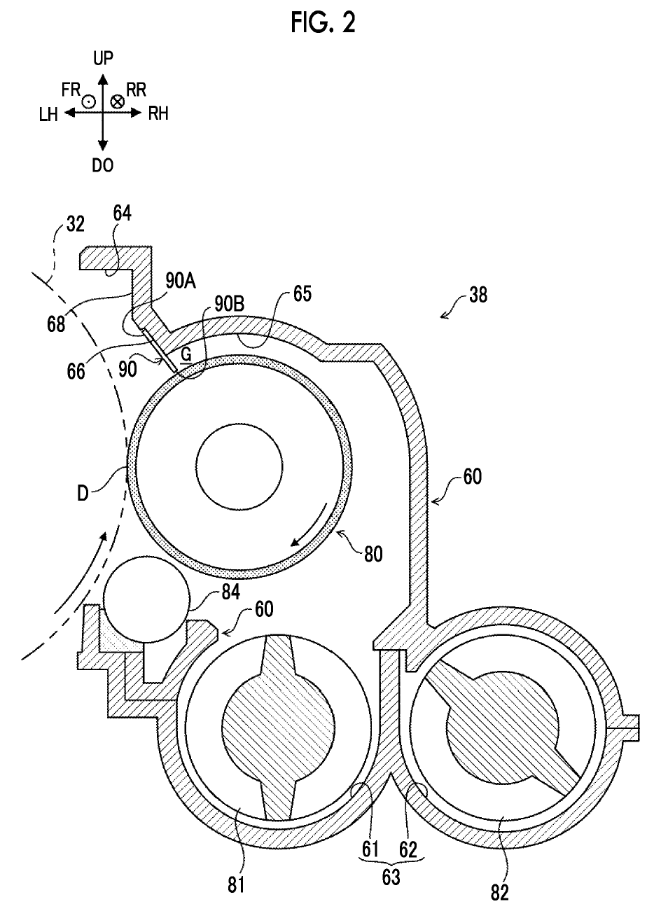

As described above, the developing device 38 shown in FIGS. 2, 3, and 4 is a device that develops the latent image held by the photoreceptor 32 with a developer. The developer is a developer that includes toner and a magnetic carrier. Specifically, the developing device 38 includes a housing 60, a developing roll 80, and a cover film 90, as shown in FIG. 2. Each part of the developing device 38 will be described below.

### Housing 60

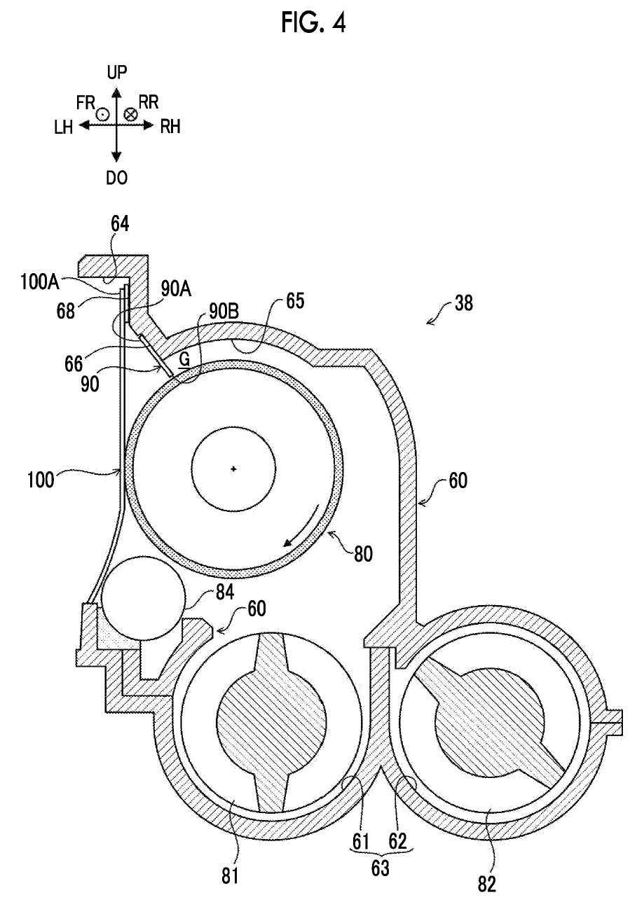

The housing 60 shown in FIGS. 2 and 4 has a function of accommodating the developer therein. In the housing 60, an opening portion 64 that is open toward a photoreceptor 32 side (specifically, the left side) is formed as shown in FIG. 2 in a state in which the developing device 38 is installed in each of the toner image forming units 20Y to 20K. In other words, the housing 60 includes the opening portion 64 that faces the photoreceptor 32.

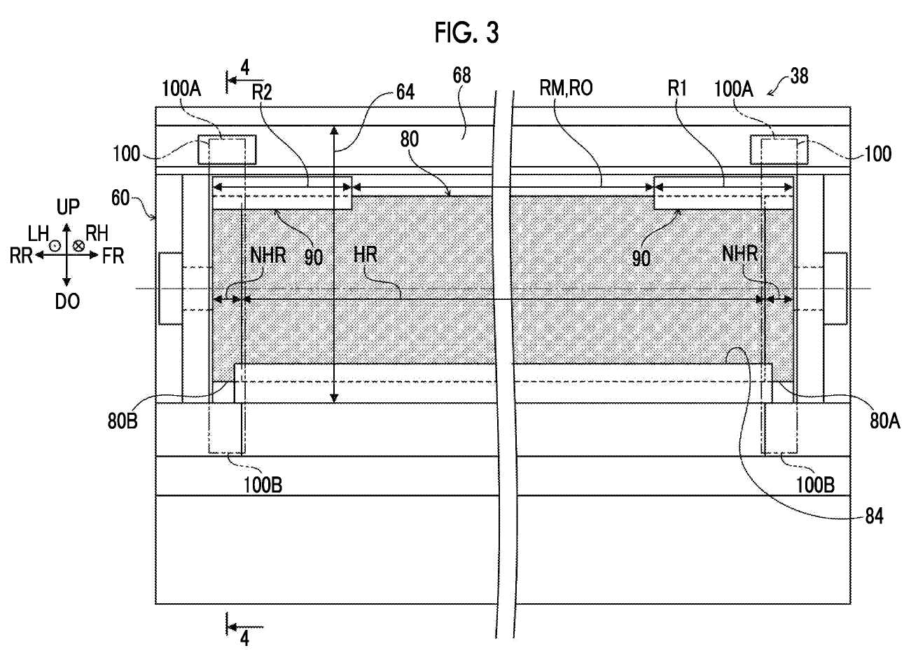

As shown in FIGS. 2 and 3, the developing roll 80 that supplies the developer to the photoreceptor 32 is provided in the housing 60 so that a part of the developing roll 80 is exposed from the opening portion 64. A layer regulating member 84 is provided on a lower side of the developing roll 80. In FIG. 2, the photoreceptor 32 is shown by a two-dot chain line in a state in which the developing device 38 is installed in the toner image forming units 20Y to 20K.

In addition, the housing 60 includes an accommodation portion 63 that accommodates the developer supplied from a supply device (not shown). The accommodation portion 63 includes a transport passage for transporting the developer supplied from the supply device. In the present exemplary embodiment, as an example, the transport passage includes a supply passage 61 and an agitation passage 62.

The supply passage 61 is disposed on the lower side with respect to the developing roll 80 along the front-rear direction. Specifically, the supply passage 61 is disposed in the front-rear direction on a rear-right oblique side with respect to the developing roll 80. The supply passage 61 accommodates the developer to be supplied to the developing roll 80. Then, the developer in the supply passage 61 is transported in a transport direction (specifically, one side in the front-rear direction). Specifically, a transport auger 81 as the transport member is disposed in the supply passage 61. By the rotation of the transport auger 81, the developer is transported in the transport direction (specifically, one side in the front-rear direction) in the supply passage 61.

The agitation passage 62 is disposed along the supply passage 61 to be adjacent to the supply passage 61. Specifically, the agitation passage 62 is disposed in the front-rear direction on the right side with respect to the supply passage 61. A front end portion and a rear end portion of the agitation passage 62 are respectively connected to a front end portion and a rear end portion of the supply passage 61. A circulation path is formed by the supply passage 61 and the agitation passage 62.

The agitation passage 62 accommodates the developer sent from the supply device as the developer to be supplied to the supply passage 61. The sent developer is transported in a direction opposite to the transport direction (specifically, the other side in the front-rear direction). Specifically, the transport auger 82 as the transport member is disposed in the agitation passage 62. By the rotation of the transport auger 82, the developer is transported in the opposite direction (specifically, the other side in the front-rear direction) to the transport direction while being agitated in the agitation passage 62.

### Developing Roll 80

The developing roll 80 is rotatably provided in the housing 60. In addition, the developing roll 80 is exposed from the opening portion 64. In addition, the developing roll 80 can hold the developer on an outer periphery thereof. The developing roll 80 has a function of developing the latent image formed on the photoreceptor 32 with the developer held thereon while rotating. Specifically, the developing roll 80 is supported by the housing 60 to be rotatable about the front-rear direction as a rotation axis direction. In addition, the developing roll 80 holds the developer on an outer peripheral surface thereof and transports the developer to a development position D facing the photoreceptor 32. The development position D mentioned herein refers to a position at which the developing roll 80 develops the latent image of the photoreceptor 32 using the developer.

Regarding the developer transported toward the development position D, the layer regulating member 84 regulates a thickness of a layer of the developer (the amount of the developer). Then, the developer (specifically, the toner) on the developing roll 80 is supplied to the photoreceptor 32 at the development position D, and the latent image (electrostatic latent image) formed on the photoreceptor 32 is developed by the developer (specifically, the toner). In addition, the developing roll 80 of the present exemplary embodiment is an example of a developing member of the present disclosure.

### Cover Film 90

As shown in FIGS. 2, 3, and 4, the cover film 90 is a member having a function of preventing the developer from leaking from the housing 60. The cover film 90 is an example of a covering member. As shown in FIG. 2, the cover film 90 is disposed downstream of the development position D in a rotation direction of the developing roll 80.

The cover film 90 is a member that covers a gap G between the developing roll 80 and the housing 60. Here, the gap G is a gap located downstream of the development position D in the rotation direction of the developing roll 80 among gaps between the developing roll 80 and the housing 60. Specifically, the gap G is a gap formed between a ceiling portion 65 of the housing 60 and the developing roll 80 as shown in FIGS. 2 and 4. In addition, as shown in FIG. 3, the cover film 90 covers the gap G as viewed from an opening portion 64 side.

As shown in FIG. 3, the cover film 90 covers a first region R1 in the gap G corresponding to one end portion 80A of the developing roll 80 in the rotation axis direction. In addition, the cover film 90 covers a second region R2 in the gap G corresponding to the other end portion 80B of the developing roll 80 in the rotation axis direction. Specifically, the first region R1 and the second region R2 of the gap G are covered with a pair of the cover films 90, respectively. In the present exemplary embodiment, as an example, the one end portion 80A of the developing roll 80 is located on the front side in the front-rear direction. That is, the one end portion 80A of the developing roll 80 may be referred to as a front end portion. The present disclosure is not limited to this configuration, and the one end portion 80A of the developing roll 80 may be located on the rear side in the front-rear direction. In addition, the other end portion 80B of the developing roll 80 in the rotation axis direction is an end portion on a side opposite to the one end portion 80A in the rotation axis direction. Accordingly, both end portions of the developing roll 80 in the rotation axis direction refer to the one end portion 80A and the other end portion 80B of the developing roll 80.

The developing roll 80 is configured to include the one end portion 80A, the other end portion 80B, and an intermediate portion 80C located between both end portions in the rotation axis direction. The end portion of the developing roll 80 in the rotation axis direction refers to a portion from an end surface in the rotation axis direction to, for example, 5% to 20% of a roll length. Here, the roll length is a length of a roll portion of the developing roll 80 in the rotation axis direction. The intermediate portion 80C of the developing roll 80 refers to a portion between both end portions in the rotation axis direction.

As shown in FIG. 3, the cover film 90 is disposed so as not to cover at least a part of an intermediate region RM in the gap G corresponding to the intermediate portion 80C of the developing roll 80. Specifically, the gap G is configured to include the first region R1, the second region R2, and the intermediate region RM. Here, for example, the first region R1 of the gap G is covered with one cover film 90. The second region R2 of the gap G is covered with the other cover film 90. In addition, a part of the intermediate region RM of the gap G between the pair of cover films 90 is not covered. That is, the portion of the intermediate region RM of the gap G between the pair of cover films 90 is open. This open region allows for pressure release of the housing 60.

In addition, in the gap G, a region corresponding to each portion of the developing roll 80 in the rotation axis direction refers to a region in a direction orthogonal to the rotation axis direction of each portion.

One cover film 90 may cover a part of the intermediate region RM adjacent to the first region R1 in addition to the first region R1 of the gap G. The other cover film 90 may cover a part of the intermediate region RM adjacent to the second region R2 in addition to the second region R2 of the gap G.

The developer is supplied to the developing roll 80 from the one end portion 80A to the other end portion 80B of the developing roll 80 in the housing 60. Specifically, the developer is supplied to the developing roll 80 from the supply passage 61. In the present exemplary embodiment, as an example, the developer is transported from the front side to the rear side of the supply passage 61. Therefore, the developer is supplied from the supply passage 61 to the developing roll 80 in a direction from the one end portion 80A toward the other end portion 80B of the developing roll 80.

As shown in FIG. 3, in the gap G, a region that is not covered with the pair of cover films 90 is formed in the intermediate region RM. The region that is not covered refers to the open region of the gap G (hereinafter, simply referred to as an open region RO). The open region RO is set to, for example, preferably 1/3 or more of a length, along the rotation axis direction, of a holding region HR of the developing roll 80 that holds the developer. An outer periphery of the roll portion of the developing roll 80 of the present exemplary embodiment is configured to include the holding region HR that holds the developer and a non-holding region NHR that does not hold the developer. The non-holding region NHR is formed at each of end portions of the roll portion in the rotation axis direction. The holding region HR is formed between the non-holding regions NHR on both sides of the roll portion in the rotation axis direction.

In addition, as shown in FIG. 3, the end portion of the developing roll 80 in the rotation axis direction in the present exemplary embodiment includes a part of the holding region HR adjacent to the non-holding region NHR. Therefore, in the gap G, the non-holding region NHR and the part of the holding region HR of the developing roll 80 are covered with the cover film 90.

The cover film 90 is fixed to a fixing portion 66 provided at the ceiling portion 65 of the housing 60, which is located downstream of the development position D in the rotation direction of the developing roll 80. The fixing portion 66 is inclined toward the developing roll 80. Specifically, the fixing portion 66 is inclined toward the developing roll 80 in a rear-right oblique direction. A base end portion 90A of the cover film 90 is fixed to the fixing portion 66. A tip end portion 90B of the cover film 90 is a free end. The tip end portion 90B of the cover film 90 is disposed in the vicinity of the outer peripheral surface of the developing roll 80. Specifically, the tip end portion 90B of the cover film 90 is disposed to be in contact with the developer held by the developing roll 80. The tip end portion 90B of the cover film 90 may be in contact with the outer peripheral surface of the developing roll 80. In addition, for example, adhesion or fastening may be used as a method of fixing the cover film 90 to the fixing portion 66. Examples of the adhesion include adhesion using an adhesive or an adhesive tape. In addition, examples of the fastening include adhesion using a screw material. The method of fixing the cover film 90 to the fixing portion 66 is not limited to the above.

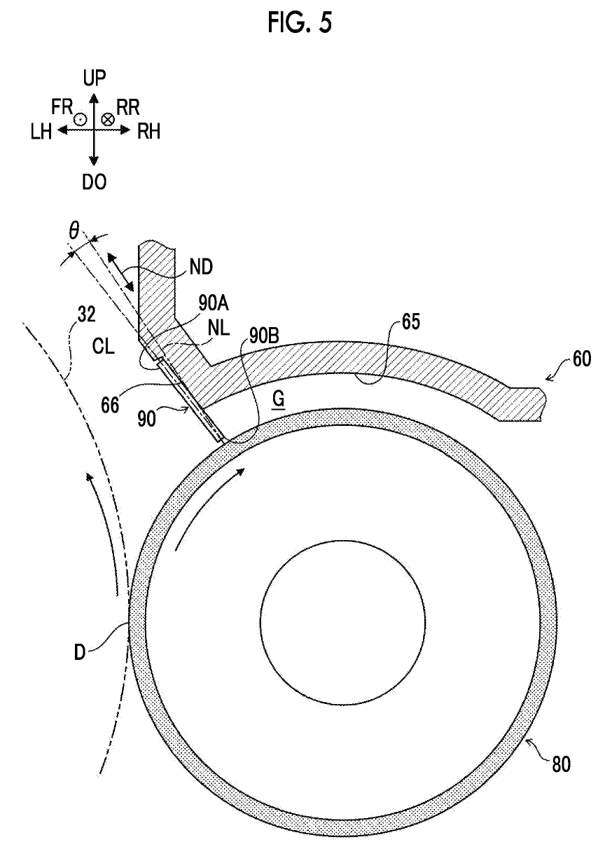

The cover film 90 may extend from the housing 60 toward the developing roll 80 along a normal direction ND of the developing roll 80. Here, the cover film 90 extending along the normal direction ND includes, for example, a case where the cover film 90 is inclined at 10 degrees or less with respect to the normal direction ND. Specifically, as shown in FIG. 5, the cover film 90 may extend such that an angle θ formed between a center line CL of the cover film 90 and a normal line NL on the outer peripheral surface of the developing roll 80 is 0 degrees or more and 10 degrees or less. Here, the center line CL of the cover film 90 is a straight line passing through a center of the cover film 90 in a thickness direction. The normal line NL on the outer peripheral surface of the developing roll 80 is a normal line at an intersection between an extension line of the center line CL and the outer peripheral surface of the developing roll 80. The normal direction ND is a direction along the normal line NL.

As shown in FIG. 5, in the cover film 90, the base end portion 90A fixed to the housing 60 is located on the photoreceptor 32 side, and the tip end portion 90B is located on a rotation center side of the developing roll 80.

The cover film 90 may be formed of, for example, a resin film. As the resin forming the cover film 90, for example, polyethylene terephthalate (PET) may be used.

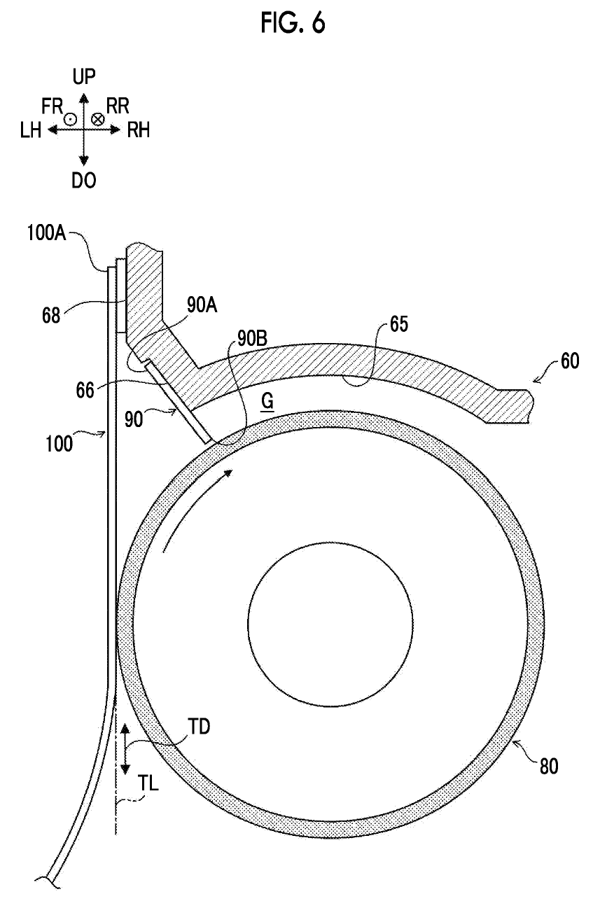

In addition, the developing device 38 may include a side seal 100 that extends along a tangential direction TD of the developing roll 80 as shown in FIGS. 3 and 4. In the present exemplary embodiment, as an example, the tangential direction TD refers to a direction along a tangent line TL at the development position D. The side seal 100 is an example of a sealing member that seals a space between the end portion of the developing roll 80 in the rotation axis direction and the housing 60. Both end portions of the developing roll 80 in the rotation axis direction are sealed by a pair of the side seals 100, respectively. The side seal 100 extending along the tangential direction TD includes, for example, a case where the side seal 100 is inclined at 10 degrees or less with respect to the tangential direction TD. Specifically, an upper end portion 100A of the side seal 100 is fixed to a wall portion 68 of the housing 60 that connects the fixing portion 66 and the opening portion 64. The side seal 100 extends from the wall portion 68 toward the developing roll 80. More specifically, the side seal 100 extends from the wall portion 68 toward the developing roll 80 to be in contact with the developing roll 80. In the present exemplary embodiment, as an example, the side seal 100 extends linearly from the wall portion 68 toward the developing roll 80 and is in contact with the outer periphery of the developing roll 80. That is, as shown in FIG. 6, the side seal 100 extends from the wall portion 68 along the tangential direction TD of the developing roll 80. The side seal 100 may extend in a curved shape from the wall portion 68 and may be in contact with the outer periphery of the developing roll 80. A lower end portion 100B of the side seal 100 is fixed to an inner wall of the housing 60 located upstream of the development position D.

The side seal 100 of the present exemplary embodiment is, for example, a film material. As the film material, the same material as a material of the cover film 90 may be used.

Next, an action of the present exemplary embodiment will be described.

In the developing device 38 of the present exemplary embodiment, in the gap G, in the regions corresponding to both end portions of the developing roll 80 in the rotation axis direction, the developer tends to leak out more easily than in the intermediate region RM because the developer circulates in the transport passage. Therefore, in the developing device 38 of the present exemplary embodiment, the first region R1 of the gap G is covered with the cover film 90. In the developing device 38, the cover film 90 suppresses the developer from leaking out from the first region R1 of the gap G.

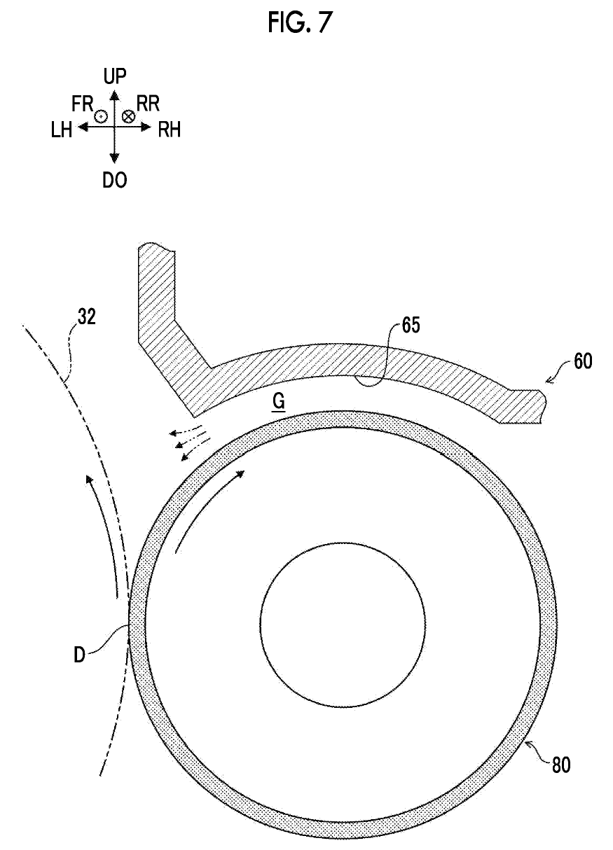

In the developing device 38 of the present exemplary embodiment, in the gap G, a region where at least a part of the intermediate region RM is not covered, that is, the open region RO is provided. By providing the open region RO in this manner, even in a case where an internal pressure of the housing 60 starts to rise due to an operation of the developing device 38, fluid (gas) leaks from the open region RO (see FIG. 7). Therefore, in the developing device 38 of the present exemplary embodiment, since the open region RO for pressure release is provided compared to a configuration in which the entire region of the gap G is covered with the cover film 90, an increase in the internal pressure of the housing 60 can be suppressed.

In the developing device 38 of the present exemplary embodiment, the second region R2 of the gap G is covered with the cover film 90. Therefore, in the developing device 38, the cover film 90 suppresses the developer from leaking out from the second region R2 of the gap G. That is, in the developing device 38, the leakage of the developer can be suppressed compared to a configuration in which only the first region R1 is covered with the cover film 90.

In the developing device 38 of the present exemplary embodiment, the first region R1 and the second region R2 of the gap G are covered with the pair of cover films 90. In the developing device 38 of the present exemplary embodiment, a position of the cover film 90 is easily adjusted with respect to the gap G, compared to a configuration in which the first region R1 and the second region R2 of the gap G are covered with one cover film 90. In addition, the amount of the material used for the cover film 90 can be reduced.

In the developing device 38 of the present exemplary embodiment, the developer is supplied to the developing roll 80 in a direction from the one end portion 80A toward the other end portion 80B in the rotation axis direction of the developing roll 80 in the housing 60. Specifically, on an upstream side in a supply direction of the developer, the developer has a low charge level, and the developer tends to fly around as dust. Therefore, in a case where the developer is supplied from the one end portion 80A to the other end portion 80B of the developing roll 80 in the housing 60, the first region R1 in the gap G corresponding to the one end portion 80A is covered with the cover film 90. As a result, it is possible to suppress the leakage of the developer compared to a configuration in which only the second region R2 of the developing roll 80 in the gap G is covered with the cover film 90.

In the developing device 38 of the present exemplary embodiment, the region in the gap G that is not covered with the cover film 90 is set to 1/3 or more of the length of the holding region HR of the developing roll 80. Specifically, the open region RO in the gap G is set to be 1/3 or more of the length. Therefore, in the developing device 38 of the present exemplary embodiment, an increase in the internal pressure of the housing 60 can be suppressed compared to a configuration in which the open region RO in the gap G is set to be less than 1/3 of the length.

In the developing device 38 of the present exemplary embodiment, the cover film 90 extends from the housing 60 toward the developing roll 80 along the normal direction ND of the developing roll 80. Therefore, in the developing device 38 of the present exemplary embodiment, a length of the cover film 90 from the base end portion 90A to the tip end portion 90B can be shortened compared to a configuration in which the cover film 90 extends along the tangential direction of the developing roll 80.

In the developing device 38 of the present exemplary embodiment, the tip end portion 90B of the cover film 90 is located downstream of the base end portion 90A in the rotation direction of the developing roll 80. Therefore, in the developing device 38, curling of the cover film 90 caused by an increase in the internal pressure of the housing 60 can be suppressed compared to a configuration in which the tip end portion 90B of the cover film 90 is located upstream of the base end portion 90A in the rotation direction of the developing roll 80.

### Other Exemplary Embodiments

In the above-described exemplary embodiment, the developer is supplied to the developing roll 80 in a direction from the one end portion 80A toward the other end portion 80B of the developing roll 80 in the housing 60, but the present disclosure is not limited to this configuration. The developer may be supplied to the developing roll 80 in a direction from the other end portion 80B toward the one end portion 80A of the developing roll 80 in the housing 60. In addition, in the above-described exemplary embodiment, the cover film 90 covers each of the first region R1 and the second region R2 of the gap G, but the present disclosure is not limited to this configuration. The cover film 90 may be configured to cover only the first region R1.

In the above-described exemplary embodiment, the pair of cover films 90 are fixed to the housing 60 so as to cover the first region R1 and the second region R2, but the present disclosure is not limited to this configuration. For example, a portion of a long cover film corresponding to the intermediate region RM of the gap G may be cut out to form the open region RO. A plurality of slits may be formed to form the open region RO. In addition, one or a plurality of through-holes may be provided in a portion of the cover film corresponding to the intermediate region RM of the gap G to form the open region RO.

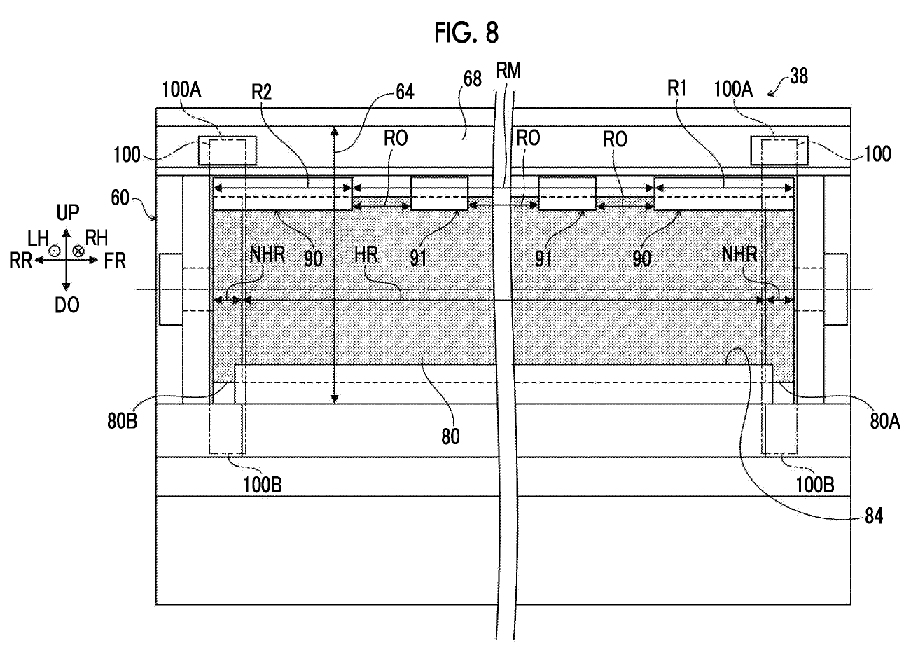

In addition, in the above-described exemplary embodiment, the intermediate region RM and the open region RO have the same size, but the present disclosure is not limited to this configuration. For example, as shown in FIG. 8, a part of the intermediate region RM may be covered with the cover film 91.

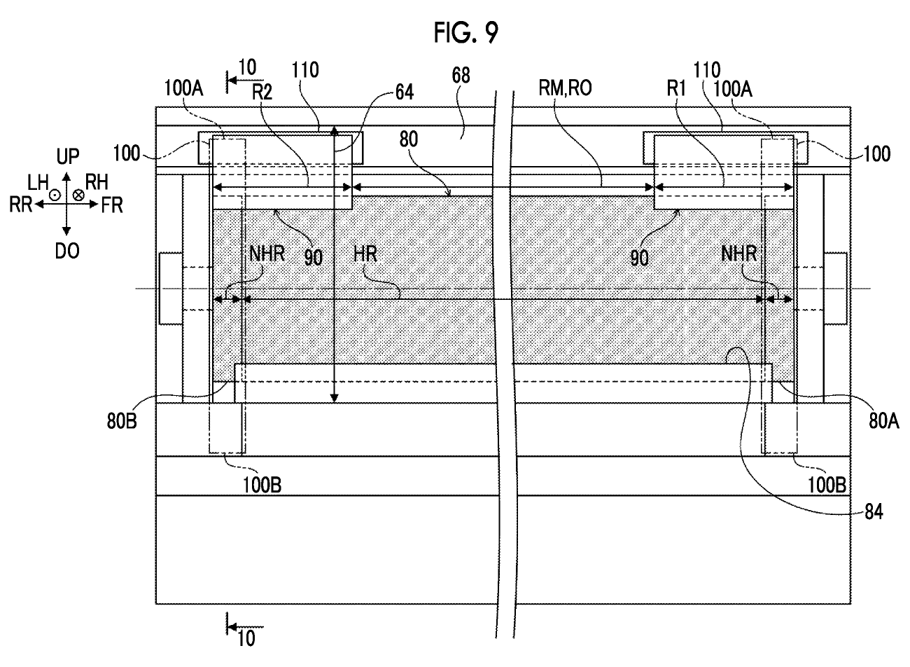

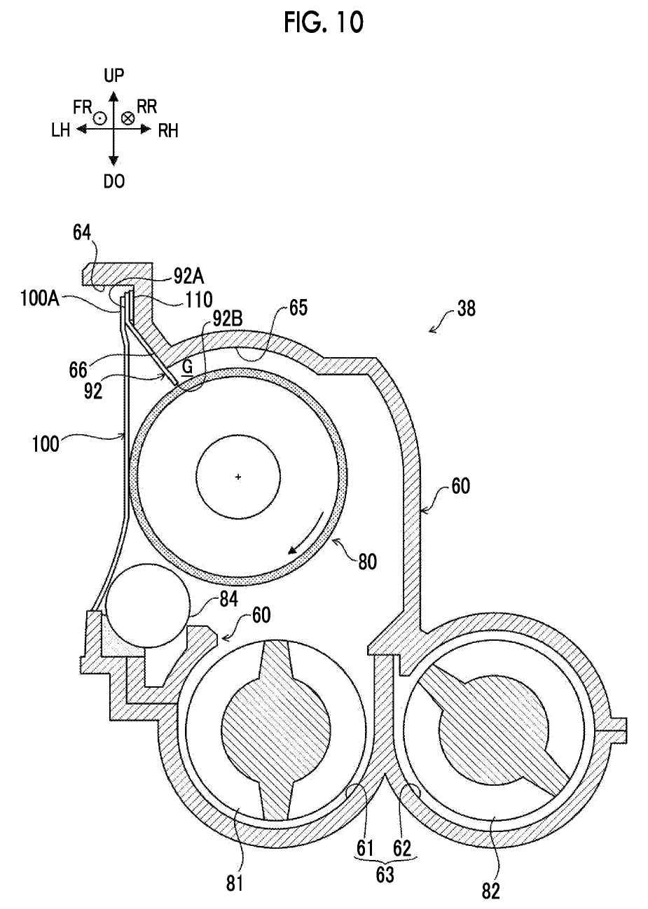

In the above-described exemplary embodiment, the cover film 90 and the side seal 100 are fixed to different portions of the housing 60, but the present disclosure is not limited to this configuration. For example, as shown in FIGS. 9 and 10, a configuration may be adopted in which the cover film 90 and the side seal 100 are fixed to the housing 60 via a fixing member 110. Specifically, a configuration may be adopted in which the cover film 90 and the side seal 100 are fixed to the fixing member 110, and the fixing member 110 is fixed to the housing 60. With such a configuration, a process of fixing the side seal 100 and the cover film 90 to the housing 60 can be easily performed, compared to a configuration in which the cover film 90 and the side seal 100 are separately fixed to the housing 60. The cover film 90 and the side seal 100 may be fixed to the fixing member 110 by adhesion or fastening. In addition, the fixing of the fixing member 110 and the housing 60 may also be performed by adhesion or fastening.

In the above-described exemplary embodiment, the housing 60 is not provided with a through-hole for pressure release, but the present disclosure is not limited to this configuration. For example, the housing 60 may be provided with a through-hole for pressure release in a portion corresponding to the other end portion 80B of the developing roll 80. There is a tendency for an increase in the internal pressure in the housing 60 to be suppressed around the portion where the through-hole for pressure release is provided. Therefore, in a case where the housing 60 is provided with the through-hole for pressure release, for example, the cover film 90 may be provided on a side opposite to a side on which the through-hole for pressure release is provided. In this case, the leakage of the developer from the gap G can be suppressed, compared to a configuration in which a through-hole for pressure release is provided in a portion of the housing 60 corresponding to the one end portion 80A of the developing roll 80.

The present disclosure is not limited to the above-described exemplary embodiments, and various modifications, changes, and improvements can be made within a range without deviating from the gist of the present disclosure. For example, the above-described modification examples may be configured by combining a plurality of the modification examples as appropriate.

### Supplementary Notes

(((1))) A developing device comprising: a housing that accommodates a developer and that has an opening facing an image holding body capable of holding a latent image; a developing member that is rotatably provided in the housing, that is exposed from the opening, that is capable of holding the developer on an outer periphery of the developing member, and that develops the latent image with the held developer while rotating; and a covering member that covers a gap between the developing member and the housing downstream of a development position of the developing member in a rotation direction, that covers a first region in the gap corresponding to one end portion of the developing member in a rotation axis direction, and that does not cover at least a part of an intermediate region in the gap corresponding to a region between both end portions of the developing member in the rotation axis direction.

(((2))) The developing device according to (((1))), wherein the covering member covers a second region in the gap corresponding to the other end portion of the developing member in the rotation axis direction.

(((3))) The developing device according to (((1))), wherein the first region and the second region of the gap are respectively covered with a pair of covering members.

(((4))) The developing device according to (((1))), wherein the developer is supplied to the developing member in a direction from the one end portion to the other end portion of the developing member in the rotation axis direction in the housing.

(((5))) The developing device according to any one of (((1))) to (((4))), wherein in the gap, a region that is not covered with the covering member is set to 1/3 or more of a length, along the rotation axis direction, of a holding region of the developing member that holds the developer.

(((6))) The developing device according to any one of (((1))) to (((5))), wherein the covering member extends from the housing toward the developing member along a normal direction of the developing member.

(((7))) The developing device according to any one of (((1))) to (((6))), wherein a base end portion of the covering member that extends from the housing toward the developing member and is fixed to the housing is located on an image holding body side, and a tip end portion of the covering member is located on a rotation center side of the developing member.

(((8))) The developing device according to any one of (((1))) to (((7))), further comprising: a sealing member that extends in a tangential direction of the developing member and that seals the end portion of the developing member in the rotation axis direction and the housing; and a fixing member that fixes the sealing member and the covering member to the housing.

(((9))) The developing device according to (((4))), wherein the housing is provided with a through-hole for pressure release in a portion corresponding to the other end portion of the developing member in the rotation axis direction.

(((10))) An image forming system comprising: an image holding body capable of holding a latent image; and the developing device according to any one of (((1))) to (((9))), which is disposed around the image holding body and develops the latent image with a developer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a housing that accommodates a developer and that has an opening facing an image holding body capable of holding a latent image;
a developing member that is rotatably provided in the housing, that is exposed from the opening, that is capable of holding the developer on an outer periphery of the developing member, and that develops the latent image with the held developer while rotating; and
a covering member that covers a gap between the developing member and the housing downstream of a development position of the developing member in a rotation direction, that covers a first region in the gap corresponding to one end portion of the developing member in a rotation axis direction, and that does not cover at least a part of an intermediate region in the gap corresponding to a region between both end portions of the developing member in the rotation axis direction.

2. The developing device according to claim 1,
wherein the covering member covers a second region in the gap corresponding to the other end portion of the developing member in the rotation axis direction.

3. The developing device according to claim 2,
wherein the first region and the second region of the gap are respectively covered with a pair of covering members.

4. The developing device according to claim 1,
wherein the developer is supplied to the developing member in a direction from the one end portion to the other end portion of the developing member in the rotation axis direction in the housing.

5. The developing device according to claim 1,
wherein in the gap, a region that is not covered with the covering member is set to 1/3 or more of a length, along the rotation axis direction, of a holding region of the developing member that holds the developer.

6. The developing device according to claim 2,
wherein in the gap, a region that is not covered with the covering member is set to 1/3 or more of a length, along the rotation axis direction, of a holding region of the developing member that holds the developer.

7. The developing device according to claim 3,
wherein in the gap, a region that is not covered with the covering member is set to 1/3 or more of a length, along the rotation axis direction, of a holding region of the developing member that holds the developer.

8. The developing device according to claim 4,
wherein in the gap, a region that is not covered with the covering member is set to 1/3 or more of a length, along the rotation axis direction, of a holding region of the developing member that holds the developer.

9. The developing device according to claim 1,
wherein the covering member extends from the housing toward the developing member along a normal direction of the developing member.

10. The developing device according to claim 1,
wherein a base end portion of the covering member that extends from the housing toward the developing member and is fixed to the housing is located on an image holding body side, and a tip end portion of the covering member is located on a rotation center side of the developing member.

11. The developing device according to claim 1, further comprising:
a sealing member that extends in a tangential direction of the developing member and that seals the end portion of the developing member in the rotation axis direction and the housing; and
a fixing member that fixes the sealing member and the covering member to the housing.

12. The developing device according to claim 4,
wherein the housing is provided with a through-hole for pressure release in a portion corresponding to the other end portion of the developing member in the rotation axis direction.

13. An image forming system comprising:
an image holding body capable of holding a latent image; and
the developing device according to claim 1, which is disposed around the image holding body and develops the latent image with a developer.

14. An image forming system comprising:
an image holding body capable of holding a latent image; and
the developing device according to claim 2, which is disposed around the image holding body and develops the latent image with a developer.

15. An image forming system comprising:
an image holding body capable of holding a latent image; and
the developing device according to claim 3, which is disposed around the image holding body and develops the latent image with a developer.

16. An image forming system comprising:
an image holding body capable of holding a latent image; and
the developing device according to claim 4, which is disposed around the image holding body and develops the latent image with a developer.

17. An image forming system comprising:
an image holding body capable of holding a latent image; and
the developing device according to claim 5, which is disposed around the image holding body and develops the latent image with a developer.

18. An image forming system comprising:
an image holding body capable of holding a latent image; and
the developing device according to claim 6, which is disposed around the image holding body and develops the latent image with a developer.

19. An image forming system comprising:
an image holding body capable of holding a latent image; and
the developing device according to claim 7, which is disposed around the image holding body and develops the latent image with a developer.

20. An image forming system comprising:
an image holding body capable of holding a latent image; and
the developing device according to claim 8, which is disposed around the image holding body and develops the latent image with a developer.
